(19) United States
(12) Patent Application Publication
(10) Pub. No.: US 2005/0165131 A1
(43) Pub. Date: Jul. 28, 2005

(54) Invisible ink

(76) Inventor: Terry Stovold, Saranac, NY (US)

Correspondence Address: SCHNADER HARRISON SEGAL & LEWIS, LLP, 1600 MARKET STREET, SUITE 3600, PHILADELPHIA, PA, 19103, US

(21) Appl. No.: 11/083,449

(22) Filed: Mar. 18, 2005

Related U.S. Application Data
(63) Continuation-in-part of application No. 10/942,246, filed on Sep. 15, 2004.
(60) Provisional application No. 60/509,281, filed on Oct. 6, 2003.

(51) Int. Cl. C03C 17/00; C09D 11/00

(52) U.S. Cl. 523/160; 523/161

(57) ABSTRACT

Invisible ink products and methods, particularly suitable for toys, games and books. The products include an activator-containing substrate and a leucodye-containing substrate. When the two substrates are brought together and pressure is applied the leucodye develops. The two substrates can be formed in sheets.

This application is a continuation-in-part of and claims priority to U.S. patent application Ser. No. 10/942,246, filed Sep. 9, 2004 and further claims priority to provisional application 60/509,281, having a filing date of Oct. 6, 2003, both entitled Invisible Ink.

### BACKGROUND OF THE INVENTION

There always exists a demand for novel technologies to entertain the consumer. Many printing technologies are utilized to for such entertainment. For example, invisible inks and markers, photochromic and thermochromic inks, which are heat or light reactive, coin reactive inks, glitter inks and pencil inks. Encapsulated inks can also be used for games and novelty items, however, the capsules are prone to rupture due to such processes as packaging, thereby causing the color to appear prematurely.

Games and other entertainment items using invisible inks are particularly well received by consumers; however, there are drawbacks to the existing technologies. Current technologies typically require an activating device to reveal the invisible inks, which can be easily misplaced, such as a pen or marker. The activating devices contain a substance not readily available except as sold with the games or items. If the activator is lost or misplaced, the game or other item is rendered useless. Activator devices can also add to the bulk of a product that would otherwise contain only sheets of paper or other substrates, increasing packaging size and decreasing its simplicity. Accordingly, an ink that would not require an activating device that is easily misplaced would be desirable. Additionally, many types of ink used for games and novelty items are susceptible to heat degradation, and thus will not produce a reliable, quality product.

### SUMMARY OF THE INVENTION

Embodiments of the present invention provide invisible ink products and methods that are particularly suitable for toys, games and books. The products include an activator- containing substrate and a leucodye-containing substrate. When the two substrates are brought together and pressure is applied the leucodye develops. The two substrates can be formed in sheets, thereby providing advantages over existing technologies.

### DETAILED DESCRIPTION OF THE INVENTION

Embodiments of the present invention provide a unique ink product and associated methods. The product is particularly suitable for games, toys and art products. Advantageously, the ink product separates the activator from the leucodye so the product is less susceptible to premature color development and is less sensitive to heat. The activator is disposed on or contained in a substrate, preferably in sheet form, thereby eliminating the need for easily misplaced activating devices. The leucodye is also contained on a substrate that is preferably in sheet form. Only when the leucodye-containing substrate and the activator- containing substrate are brought together and pressure or heat is applied, is the color developed. This provides a product that can be highly tolerant of heat.

In a preferred embodiment, the activator-containing substrate is placed directly on top of the leucodye-containing substrate and pressure, such as rubbing or scratching is applied to the untreated side of the activator-containing paper, thereby transferring the activator to the leucodye-containing substrate. Depending on which leucodye printed ink is underneath, each different leucodye color will appear.

The printed leucodye ink may withstand higher temperatures compared to traditional products that use a combined ink with both activator and leucodye in close proximity, which makes it more susceptible to premature color development at lower temperatures. Furthermore, the activator-containing substrate can be easily added to a book or packaging without the problems encountered with bulky crayons, markers or pencils. Additionally, the sheets are less likely to be lost or misplaced, particularly if they are packaged in a pad form.

The activator is preferably used with a coating medium such as wax or other carrier that will soften under pressure or other heat producing mechanism. In an exemplary embodiment of the invention, the coating medium has a melting point between 120° F. and 150° F., and more preferably between 130° F. and 140° F.

The activator is preferably selected from the group consisting of phenolic resin, zinc chloride bisphenol, hydroxybenzoate, amidophenol, anilides with hydroxyl groups and benzoamides with hydroxyl groups including N-(4-Hydroxyphenyl) acetamide, 2-Acetamidophenol, 3-Acetamidophenol, Salicylanilide, p-Hydroxybenzamide, p-Hydroxyphenyl acetamide, 3-Hydroxy-2-Napthanilide, o-Hydroxybenzanilide. In particular, activators such as Bisphenol A supplied by Sunoco Inc, phenolic resins like HRJ-10138 or HRJ-2609 supplied by Schenectady Chemicals, zinc chloride, other bisphenols and hydroxybenzoates are appropriate.

Illustrative Activator Coating Formulation

| | |
|---|---|
| Paraffin Wax | 60% |
| Phthalate Ester (solvent) | 10% |
| Phenolic resin | 30% |

Following is an illustrative embodiment of a method of forming the activator-containing substrate. The activator is heated (preferably above 200° F.) to dissolve in a suitable phthalate ester solvent or any other appropriate solvent. Once the activator is fully dissolved, a Paraffin wax with a melting point of about 130° F. to 140° F. is added as a coating medium to the continually heated coating mixture. Once all the activator and wax are dissolved the cooled coating mixture can be coated (with a standard paper coater) or the coating can remain heated and coated onto a wax release liner paper. If viscosity is too thick more solvent can be added and if the coating is to too thin, a polyethene wax can be heated into the coating mixture. A variation of this coating could be made with a water-based wax dispersion product, such as sold by Johnson Wax, and leucodye.

The leucodye-containing substrate may be prepared in numerous ways. One or more inks, each containing a leucodye, are printed in a non-developed form on paper or any appropriate substrate. The printing process may be for example, a flexographic, offset, gravure, coating, inkjet, thermal transfer or other process of depositing ink or coating to a given substrate. The printing process can be repeated for each ink, and inks may be printed by different processes. The term “non-developed” is used herein to describe the state of the leucodye when printed. This includes a colorless printing, which will be the ideal state for most applications. It is possible, however, that the ink will have some color to it from various components that it may contain. Different leucodye inks can be printed on a single substrate, resulting in different colors appearing when revealed with an activator.

Any leucodye can be used. Examples include Pergascript Orange I-5R, Pergascript Red I-6B, Pergascript Green I-3G, Pergascript Yellow I-3R made by Ciba Chemicals, Specialty Magenta 20, Specialty Red 747, Specialty Black 34, Specialty Magenta 16, Specialty Orange 14, Specialty Blue 1, by Noveon Hilton Davis, or other color formers whether or not synthetic organic coloring matter. It is noted that microencapsulated dyes are within the spirit and scope of the invention.

Illustrative Offset Leucodye Formulation

| | |
|---|---|
| Soya Oil/linseed oil Transparent White | 60% |
| Soya Oil/linseed oil | 10% |
| Leucodye | 30 |

The above ink may be heated if desirable, or just mixed and three roll milled until all leucodye powder is fully wet out.

A sheet of white paper or other substrate can be created that will develop to a number of different colors depending on how many inks having different leucodyes are printed. For example, if you have a six color flexographic printing press you can have six different inks, which will each rub to a different color. It is noted that the substrate does not have to be white, but can be any color, provided that the inks will show up when rubbed. Due to the fact that printing units are typically at a premium there exists a need to minimize the number of printing units, but still have as many different colors appearing after rubbing. This can be achieved by a modified process printing such as four or six color process. Process printing is essentially printing process colors (i.e.: red, blue, yellow, black) on top of one another with different screens or tints to create a different color other than the process colors in each of the printing units. For example, if only four white inks are utilized, each developing to a different color, an endless number of different colors can appear when developed.

A leucodye or ink absorption-reducing coating may be disposed on the substrate to inhibit or eliminate the spreading or absorption of the ink. It also may allow for easier color development of the inks. Preferably the coating reduces or eliminates absorption of the ink by the substrate such as coated machine calendared or surface treated substrates. An example of acceptable coated material is 60# C2S coated supplied by Wallace Thomas Packaging, of course every paper company offers several lines of coated papers, which would also be suitable. The coating need only be on the side of the paper on which the ink will be printed, however, coating on the other side may add to the integrity of the paper. Since the inks will have less absorption to such substrates they can be developed by applying less pressure.

In an illustrative embodiment, the leucodye and the activator are grinded to an appropriate size for printing on a standard flexographic printing press using a 300-350 line anilox with BCM of 1.5 to 4. They may be ground, with a binder like polyvinyl alcohol, surfactant, defoamers, and grinding agents. The mixtures may be water-based or oil-based. An exemplary oil is Soya oil. Depending on the printing method, the particle size could be as high as 25-30 microns and as low as 1 micron or sub micron. For the leucodye, particle size is preferably between five and ten microns. The activator particle size is preferably between five and 15 microns. Some examples of possible surfactants and grind aids are available from Rohm and Haas Chemicals under their Tamol line. Defoamers are available from Rohm and Hass and Air Products. One could produce an ink which could print and function with only a binder for example polyvinyl alcohol sold by Air Products under airvol line, an activator or activators and a leucodye or leucodyes in a vehicle (water or oil) without any other additives.

Many product types may be created with the activator-containing substrate and leucodye-containing substrate. Examples include toys, puzzles, art products, educational products, customer verification products, games, interactive books, stickers, tickets, placemats, cards, tags, labels, security device.

The methods and products described herein can be used to create coloring books, either having pages that are initially totally blank (use of only invisible images), or pages that are partially blank such as having an outline or scattered images. When the activator-containing paper is applied to blank areas of the pages, color development will occur to reveal the invisible images. This same process can be used on other items such as placemats, sticker, labels and puzzles. Colors can be made to appear or dissipate upon application of particular temperatures.

While the invention has been described by illustrative embodiments, additional advantages and modifications will occur to those skilled in the art. Therefore, the invention in its broader aspects is not limited to specific details shown and described herein. Modifications, for example, to the components and ratios of the activator and leucodye coatings may be made without departing from the spirit and scope of the invention. Accordingly, it is intended that the invention not be limited to the specific illustrative embodiments, but be interpreted within the full spirit and scope of the appended claims and their equivalents.

1. An invisible ink product comprising:
a substrate on which at least on ink containing a leucodye is printed colorlessly; and
an activator-containing substrate;
wherein the activator will cause the leucodye to present a color when the activator-containing substrate is brought in contact with the leucodye-containing substrate.

2. The invisible ink product of claim 1 wherein the activator-containing substrate comprises a substrate coated with a mixture of an activator and a coating medium.

3. The invisible ink product of claim 2 wherein the coating medium is a wax.

4. The invisible ink product of claim 2 wherein the coating medium has a melting point between 120° F. and 150° F.

5. The invisible ink product of claim 2 wherein the coating medium has a melting point between 130° F. and 140° F.

6. The invisible ink product of claim 1 wherein the activator is selected from the group consisting of phenolic resin, zinc chloride bisphenol, hydroxybenzoate, amidophenol, anilides with hydroxyl groups and benzoamides with hydroxyl groups.

7. The invisible ink product of claim 1 wherein the activator-containing substrate is impregnated with an activator.

8. The invisible ink product of claim 1 further comprising a leucodye absorption reducing coating disposed on the substrate.

9. A product selected from the group consisting of toy, puzzle, art product, educational product, customer verification product, game, book, sticker, ticket, placemat, card, tag and label including the ink product of claim 1.

10. A game comprising the ink product according to claim 1.

11. A coloring book comprising the ink product according to claim 1.

12. An art product comprising the ink product according to claim 1.

13. A security device comprising the ink product according to claim 1.

14. The invisible ink product of claim 1 wherein the one or more inks are printed on the leucodye-containing substrate to form an image.

15. The invisible ink product of claim 1 further comprising a visible image printed on the leucodye-containing substrate.

16. The invisible ink product of claim 1 further comprising a plurality of leucodye-containing substrates in book form in the form of a book.

17. A method of forming an ink product comprising the steps of:
treating a substrate with an activator to make an activator-containing release substrate; and
treating a substrate with one or more leucodyes to create a colorless leucodye-containing substrate;
wherein when the activator-containing release substrate is brought into contact with the leucodye-containing substrate the leucodye under pressure the leucodye(s) are developed.

18. The method of claim 17 wherein the activator is coated on the substrate.

19. The method of claim 17 wherein the activator is impregnated in the substrate.

20. The method of claim 17 further comprising including a coating medium in the activator-containing substrate.

21. The method of claim 20 wherein the coating medium is a wax.

22. The method of claim 20 wherein the coating medium has a melting point between 120° F. and 150° F.

23. The method of claim 20 wherein the coating medium has a melting point between 130° F. and 140° F.

24. The method of claim 17 wherein the activator is selected from the group consisting of phenolic resin, zinc chloride bisphenol, hydroxybenzoate, amidophenol, anilides with hydroxyl groups and benzoamides with hydroxyl groups.

25. The method of claim 17 wherein the substrate is treated with the leucodye to form an image.

26. The method of claim 17 further comprising printing a visible image on the leucodye-containing substrate.

27. The method of claim 17 further comprising creating a plurality of leucodye-containing substrates and forming a book with the substrates.
